(19) United States
(12) Patent Application Publication
(10) Pub. No.: US 2009/0048828 A1
(43) Pub. Date: Feb. 19, 2009

(54) GAP INTERPOLATION IN ACOUSTIC SIGNALS USING COHERENT DEMODULATION

(75) Inventors: Les Atlas, Seattle, WA (US); Charles Pascal Clark, Sammamish, WA (US)

Correspondence Address: LAW OFFICES OF RONALD M ANDERSON, 600 108TH AVE, NE, SUITE 507, BELLEVUE, WA, 98004, US

(73) Assignee: University of Washington, Seattle, WA (US)

(21) Appl. No.: 11/839,355

(22) Filed: Aug. 15, 2007

(51) Int. Cl. G10L 19/02

(52) U.S. Cl. 704/229; 704/E19.022

(57) ABSTRACT

Information is estimated to fill-in even relatively long gaps (e.g., up to 250 ms) that occur in a signal due to physical errors in media or transmission, where the omitted information causes signal distortion. The signal is first divided into a plurality of subbands, since the gaps in each subband are individually easier to interpolate. Coherent demodulation is then employed on each subband signal to reduce the time-varying signals to a collection of pairs of frequency-modulated carriers multiplied by complex-valued envelopes, or modulators. Standard interpolation is then separately applied to the modulators and carriers of these pairs to fill-in the gaps in each of the subbands, and the interpolated pairs are remodulated. The resulting interpolated signals from each of the subbands are recombined to form the final interpolated output signal in which the gaps are filled in with estimated data.

### BACKGROUND

When signals are transmitted wirelessly, over a conductor, or through an optical fiber, gaps in the signal data can often occur when the signal drops out or is briefly lost for various reasons, causing distortion and loss of information in the received signal. Various techniques can be employed to estimate and fill-in relatively short gaps in the signal. For example, if the signal includes gaps of a few milliseconds (ms), conventional interpolation techniques, such as the approach developed by R. Veldhuis, can be used to estimate the signal content to fill-in the short term gaps. However, these techniques fail to provide acceptable results when the duration of the gaps is too great, e.g., more than about 100 ms. The type of information being conveyed by the signal can also impact on the ability to fill in a longer gap in a signal. For example, gaps in a signal conveying music can more readily be interpolated than gaps in human voice transmissions, due to the greater variability of human speech.

It is difficult to fill-in longer duration gaps because a full bandwidth signal can vary so much more during the longer interval. One approach developed by Drori et al. for filling in longer gaps is to map the signal into the time-frequency space using the short-time Fourier transform and to divide the overall frequency of the time-frequency signal into separate overlapping frequency bands that are partitioned in time. Each frequency band is filled in by matching fragments of the signal, and a synthesized result is reconstructed. Gap filling proceeds by matching patterns of complex time-frequency fragments to the overlapping regions of existing data from the input and synthesized signal based on magnitude and phase and is performed separately in each frequency band, while maintaining coherence between overlapping bands. An overlap-addition method is used to blend together fragment boundaries to form a coherent output signal from which the gap is removed. The dependence of this algorithm on pattern matching can limit its effectiveness and accuracy.

Accordingly, it would be desirable to provide a better approach for filling gaps in signals, such as digital audio signals, where the gaps are more than 100 ms in duration. The approach should provide a reasonably accurate estimate of the missing signal information and should, for some uses, be sufficiently efficient to implement in real time.

### SUMMARY

A method has thus been developed for filling in a gap in an input signal, wherein the gap corresponds to missing information that was originally included with the input signal. The method includes the step of dividing the input signal into a plurality of subbands. Each subband includes a subband signal with a different range of frequencies than other subbands and has a bandwidth substantially less than that of the input signal. Each of the plurality of subband signals is demodulated to produce a pair of signals, including a carrier signal and a modulator signal. The carrier signal and the modulator signal comprising each pair of signals are then separately interpolated to fill in the gap in each carrier signal and in each modulator signal comprising each subband signal, forming interpolated subband signals. The interpolated subband signals are then remodulated to combine the interpolated signals for each pair, producing modified subband signals. Finally, the modified subband signals are recombined to produce an interpolated output signal in which the gap is filled-in.

The gap in the input signal can be up to about 250 milliseconds in duration. This approach also fills in shorter gaps, but much of its value lies in its ability to fill-in the longer gaps in an input signal.

In at least one exemplary embodiment, the step of dividing the input signal into the plurality of subbands includes the step of processing the input signal with a filterbank that implements short-time Fourier transforms. Appropriate windows are chosen for analysis and synthesis to produce the plurality of subbands. The bandwidth and location of each subband is selected so that no more than one carrier is included within the subband signal.

The step of recombining the modified subband signals can include the step of applying an inverse short-time Fourier transform to the modified subband signals to produce the interpolated output signal.

When demodulating each of the plurality of subband signals, the carrier signal is detected in a subband signal. The subband signal is then divided by the carrier signal to determine the modulator signal for the subband. The step of dividing the subband signal can include the step of multiplying a complex conjugate of the carrier signal for the subband by the subband signal to determine the modulator signal for the subband signal. In one exemplary technique, the step of detecting the carrier signal includes using a sliding M-point window to obtain sequential short-time segments of the subband signal. A length of the sliding M-point window corresponds to an interval of time during which an instantaneous frequency of the subband is expected to remain constant. A spectral center-of-gravity for the sliding M-point window is then determined, and a phase of the carrier signal for the subband is determined.

The step of interpolating the modulator signal for a subband can include down sampling the modulator signal for the subband. A gap interpolator is then applied to the modulator signal that was down sampled to provide an interpolated down sampled modulator signal, and the interpolated down sampled modulator signal is up sampled to produce an interpolated modulator signal.

There are two exemplary approaches that can be employed for interpolating the carrier signal. In one approach, a relatively long instantaneous frequency detection window is selected during the step of demodulating, so that the instantaneous frequency detection window is longer than the gap. As a result, the instantaneous frequency detection window implicitly interpolates the carrier signal by averaging the instantaneous frequency detection window over the gap. In the other exemplary approach, the carrier signal is interpolated by interpolating an instantaneous frequency signal of the carrier signal, instead of directly interpolating the carrier signal. This step produces an interpolated instantaneous frequency signal, and an interpolated carrier signal can then be determined from the interpolated instantaneous frequency signal.

Another aspect of this novel approach is directed to a memory medium on which machine readable and executable instructions are stored. These machine instructions enable functions that are generally consistent with the steps of the method discussed above to be implemented.

Yet another aspect of this technology is directed to a system for filling in a gap in an input signal, wherein the gap corresponds to missing information that was originally included with the input signal. The system includes a memory in which are stored machine executable instructions, an interface that accesses the input signal in which the gap has occurred, and a processor that is coupled to the memory and to the interface. The processor executes the machine executable instructions to carry out a plurality of functions that are also generally consistent with the steps of the method discussed above.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is an exemplary schematic function block diagram illustrating a filter bank decomposition of an input data signal and subsequent modification, followed by a recombination of subbands to produce an output data signal in which even relatively long gaps are filled in;

FIG. 2 is an exemplary schematic functional block diagram showing further details of a modification block from FIG. 1;

FIG. 3A is an exemplary schematic functional block diagram showing further details of a coherent demodulation block used in the procedure illustrated in FIG. 1;

FIG. 3B is an exemplary schematic functional block diagram illustrating details of a block in FIG. 3A that detects the carrier;

FIG. 4 is an exemplary schematic functional block diagram illustrating details of a procedure for use in a modulator to fill-in gaps in the data signal;

FIG. 5 is an exemplary flowchart illustrating the logical steps employed in one exemplary embodiment of the present approach to fill-in gaps in a data signal; and

FIG. 6 is a functional block diagram of a computing device (e.g., a personal computer) that is generally usable to carry out the novel approach that is discussed herein.

### DESCRIPTION

### Figures and Disclosed Embodiments Are Not Limiting

Exemplary embodiments are illustrated in referenced Figures of the drawings. It is intended that the embodiments and Figures disclosed herein are to be considered illustrative rather than restrictive. No limitation on the scope of the technology and of the claims that follow is to be imputed to the examples shown in the drawings and discussed herein.

### Description of Approach for Filling Longer Gaps in Data

There are three main components of an interpolation technique used in an exemplary embodiment that is employed to fill-in gaps in data of a signal, even when the gaps are longer than 100 ms in duration. These three components are a perfect-reconstruction filterbank; a coherent demodulator; and a signal interpolator. Each of these components is described in detail below.

### Perfect-Reconstruction Filterbank

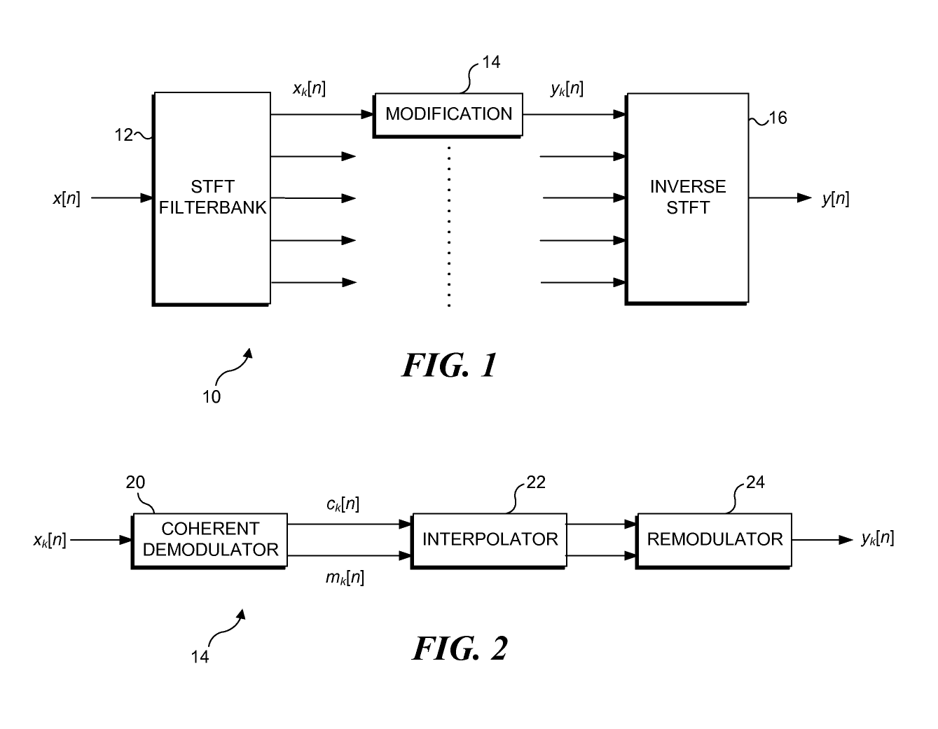

The first step in the interpolation process is to separate the input signal x[n] that includes the gaps with missing data into subbands xₖ[n], as indicated in a functional block diagram 10 in FIG. 1. Since the subbands will subsequently be recombined to produce the final repaired signal y[n] that is output, a filterbank 12 employed in this exemplary embodiment is based on the short-time Fourier transform (STFT), with appropriately chosen analysis and synthesis windows to ensure perfect reconstruction of unmodified subbands. As is characteristic of an STFT, the filterbank subbands are equally spaced in frequency and have equal bandwidth. The bandwidth and location is selected such that there will generally be no more than one carrier within a subband. A useful bandwidth for practicing this exemplary approach is approximately 100 Hz. Thus, an audio signal may be divided into more than 500 subbands of about 100 Hz bandwidth each.

A block 14 labeled “Modification” in FIG. 1 encapsulates coherent demodulation and interpolation. As depicted in the additional details of block 14 illustrated in FIG. 2, each subband is demodulated by a coherent demodulator 20, so that the associated modulator mₖ[n] and carrier cₖ[n]of the subband can be individually interpolated by an interpolator 22. Following this interpolation, the new modulator and carrier are remodulated by a remodulator 24, to produce a modified subband yₖ[n].

### Coherent Demodulator/Remodulator

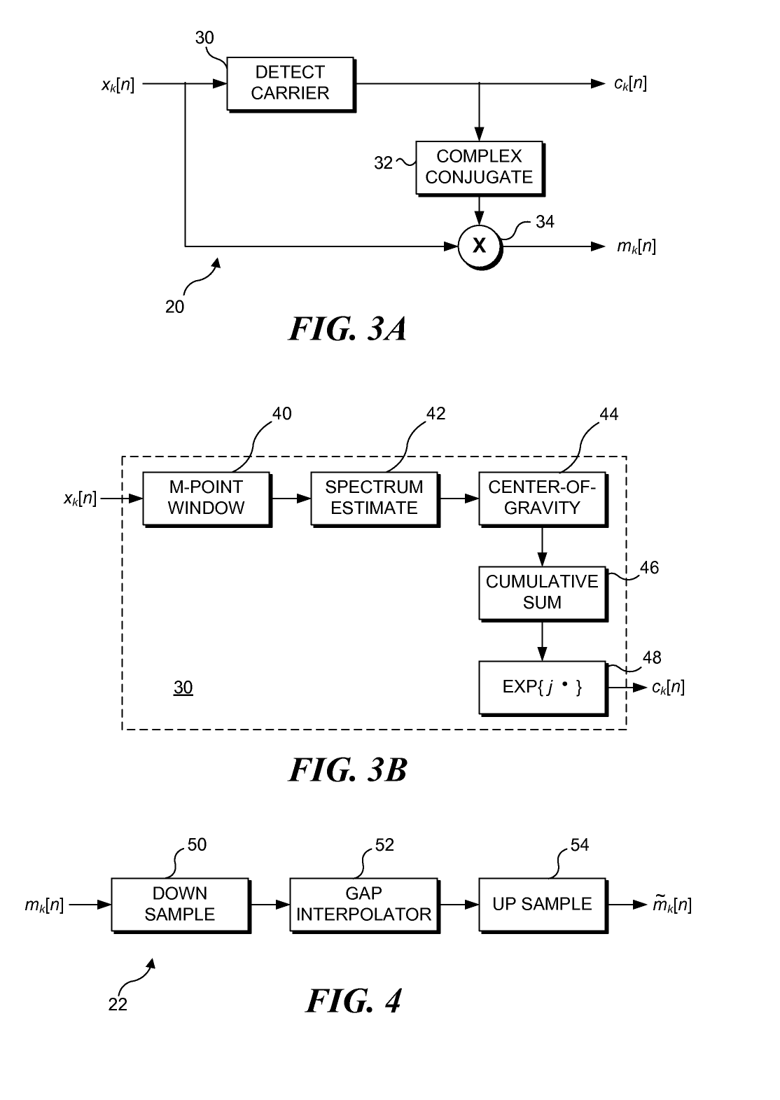

Given a subband xₖ[n], the demodulation of the subband signal proceeds as follows. First, a carrier detector 30 carries out the carrier detection portion of the process and determines a time-varying instantaneous frequency (IF) estimate from which it computes the carrier signal cₖ[n]. Then, division of xₖ[n] by the carrier yields the modulator mₖ[n]. The process is illustrated in FIG. 3A and is described in more detail below.

As shown in FIG. 3B, carrier detector 30 uses a sliding M-point window 40 to obtain sequential short-time segments of xₖ[n]. Assuming that the carrier IF varies slowly with time, the length of the window corresponds to the interval during which the instantaneous frequency of xₖ[n] is expected to remain constant.

For each window, a spectral center-of-gravity 44 is obtained from the following relationship:

$$\overline{ω} [ n ] = \frac{{\int }_{0}^{π} ω {S}_{k , n} ( ω ) d ω}{{\int }_{0}^{π} {S}_{k , n} ( ω ) d ω} , \qquad ( 1 )$$

where S_{k,n}(ω) is a power spectral density estimate 42 of the windowed segment centered on time n. The above formula uses the theoretical discrete time Fourier transform (DTFT) for illustrative purposes only. In practice, the spectral center-of-gravity is determined using discrete summations determined by taking a cumulative sum 46 of the DTFT of xₖ[n].

Once the IF has been determined, the phase of the carrier signal is defined as follows:

$$φ [ n ] = Δ t {\sum }_{m = 0}^{N - 1} \overline{ω} [ n ] , \qquad ( 2 )$$

where Δt is the sampling interval of x[n]. Then, the carrier signal becomes:

cₖ[n]=e^{jΦ[n]}, (3)

which is unimodular as required. Also, cₖ[n] is band limited, since the spectral-center-of-gravity computation constrains 1̅0̅7̅[n] to a relatively slowly-varying interval within the bandwidth of xₖ[n].

Referring back to FIG. 3A, the modulator mₖ[n] follows from the division of the analytic signal \tilde{x}ₖ[n] by cₖ[n], which is the same as multiplying by a complex conjugate 32 of the carrier (the multiplication step is indicated by a multiplier symbol 34), i.e.,

mₖ[n]=xₖ[n]·cₖ*[n], (4)

where * denotes the complex conjugate in regard to the carrier. Owing to the nature of cₖ[n] as a unimodular complex exponential (as indicated by a block 48 in FIG. 3B), this operation need not be concerned with the possibility of division-by-zero. As a result, mₖ[n] is well-defined for all n.

Thus, the remodulation step performed by remodulator 24 in FIG. 2 simply multiplies the modulator and carrier together in the time-domain to obtain a bandpass signal. In the exemplary gap fill-in procedure, each modulator and carrier pair are separately interpolated to yield \tilde{m}ₖ[n] and \tilde{c}ₖ[n]. After interpolation, the remodulator in FIG. 2 multiplies the modified signals together to form the interpolated subband, yₖ[n]:

yₖ[n]=\tilde{m}ₖ[n]·\tilde{c}ₖ[n]. (5)

As indicated in FIG. 1, each yₖ[n] obtained in this manner provides an input for an inverse STFT operation 16 that produces the final output y[n].

### Interpolator

Interpolation of missing data has been studied extensively in the literature. The exemplary approach used for interpolation uses a well-known technique, which poses the interpolation problem in terms of optimal least-squares filters derived from the second-order statistics of the known signal samples. The difference between the previously known technique and the present approach used in this exemplary embodiment is that the present approach applies this technique to modulators and carriers rather than to a full-band signal, as is conventionally done when interpolators have previously been used.

A modulator mₖ[n] is band limited and low pass in frequency, so it can be down sampled considerably without aliasing. This technique reduces the redundancy in the signal as well as the computation required to interpolate across the gap to provide fill-in data. FIG. 4 shows the modulator interpolation process performed by interpolator 22, including a down sample block 50, a gap interpolator 52, and an up sample block 54, where up sampling includes an anti-imaging post-filter.

Carrier interpolation is handled in one of two ways. The simplest approach is to choose a long IF-detection window in the coherent demodulation stage. Setting the window to be longer than the gap implicitly interpolates the IF by averaging it over the gap. In this case, no further interpolation is required beyond the basic carrier detection stage.

The second interpolation method for the carrier is essentially the same as depicted in FIG. 4 for the modulator, except that the slowly-varying IF φₖ[n] is interpolated by gap interpolator 52 rather than the carrier signal itself. The new carrier \tilde{c}ₖ[n] is then computed from the interpolated IF \tilde{φ}ₖ[n] using Eqs. (2) and (3). The interpolated modulator and carrier signals are input to remodulator 24 (FIG. 2), which produces the input to inverse STFT block 16 (FIG. 1).

### Summary—Exemplary Logical Steps Employed to Fill-In Gaps in Data Signal

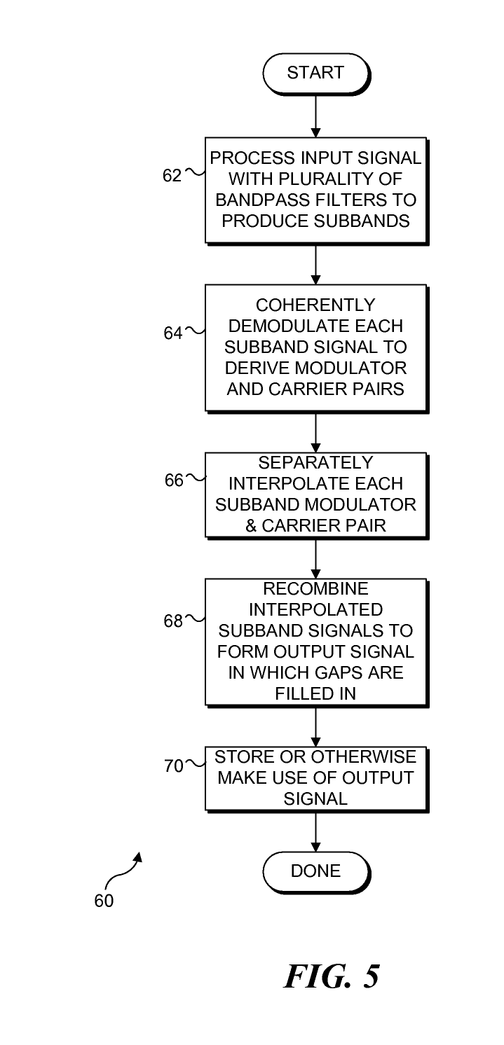

The preceding process is summarized by the exemplary logical steps illustrated in a flowchart 60 in FIG. 5. A step 62 processes the input signal that includes gaps in the data conveyed thereby with a plurality of bandpass filters to produce a plurality of successive subbands of much narrower bandwidth (e.g., about 100 Hz) than the input signal. A step 64 then coherently demodulates each subband signal to derive modulator and carrier pairs for each subband. In a step 66, each subband modulator and carrier pair is then separately input to an interpolator which interpolates the data to fill-in the gaps. Since this interpolation is being carried out separately for the modulator and for the carrier, and is only being done on a relatively narrow bandwidth portion of the full spectrum of the input signal, the interpolation can fill-in much longer gaps than can be done with full bandwidth interpolation techniques. A step 68 then recombines the interpolated subband signals to produce the output signal in which the gaps in the data have been filled in. Finally, in a step 70, the output signal is stored, or some other physical use is made of the signal which has been processed automatically to fill-in the gaps.

### Computing System Suitable for Carrying Out Novel Technique

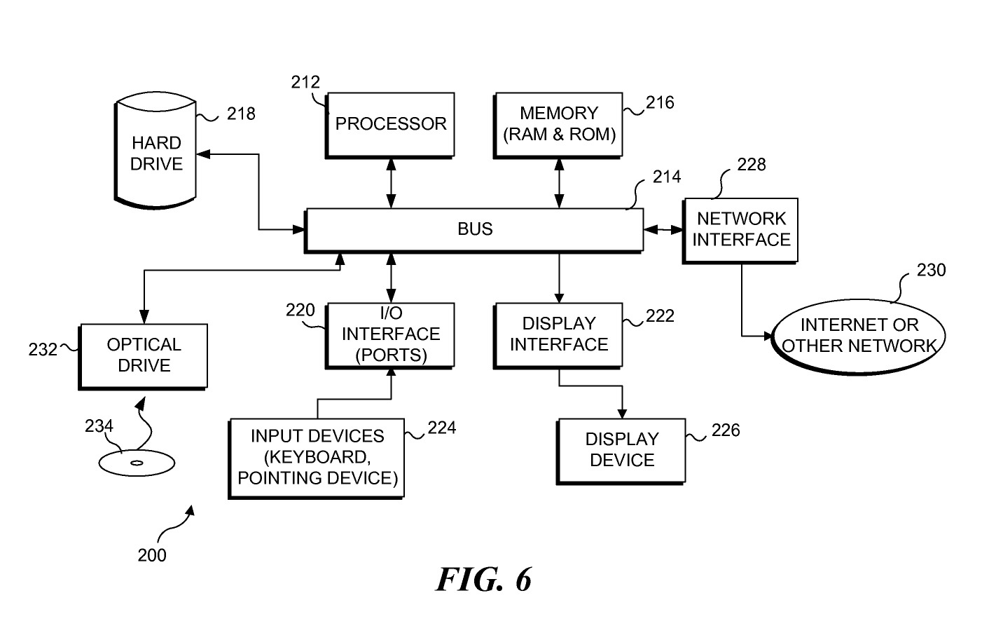

FIG. 6 illustrates details of a functional block diagram for a computing device 200. The computing device can be a typical personal computer, but can take other forms. A processor 212 is employed for executing machine instructions that are stored in a memory 216. The machine instructions may be transferred to memory 216 from a data store 218 over a generally conventional bus 214, or may be provided on some other form of memory media, such as a digital versatile disk (DVD), a compact disk read only memory (CD-ROM), or other non-volatile memory device. An example of such a memory medium is illustrated by a CD-ROM 234. Processor 212, memory 216, and data store 218, which may be one or more hard drive disks or other non-volatile memory, are all connected in communication with each other via bus 214. The machine instructions are readable by the processor and executed by it to carry out the functions discussed above in regard to the exemplary embodiments. Also connected to the bus are a network interface 228, an input/output interface 220 (which may include one or more data ports such as a serial port, a universal serial bus (USB) port, a Firewire (IEEE 1394) port, a parallel port, a personal system/2 (PS/2) port, etc.), and a display interface or adaptor 222. The input signal in which one or more gaps has occurred can be provided through the input/output interface. Alternatively, the input signal with one or more gaps may be provided in a form of a stored signal on a memory medium such as a floppy disk, or an optical storage medium, or may have been previously stored on data store 218 after being received over a connection to a network or from some other source. Any one or more of a number of different input devices 224 such as a keyboard, mouse or other pointing device, trackball, touch screen input, etc., are connected to I/O interface 220. A monitor or other display device 226 is coupled to display interface 222, so that a user can view graphics and text produced by the computing system as a result of executing the machine instructions, both in regard to an operating system and any applications being executed by the computing system, enabling a user to interact with the system. An optical drive 232 is included for reading (and optionally writing to) CD-ROM 234, or some other form of optical memory medium.

Although the concepts disclosed herein have been described in connection with the preferred form of practicing them and modifications thereto, those of ordinary skill in the art will understand that many other modifications can be made thereto within the scope of the claims that follow. Accordingly, it is not intended that the scope of these concepts in any way be limited by the above description, but instead be determined entirely by reference to the claims that follow.

The invention in which an exclusive right is claimed is defined by the following:

1. A method for filling in a gap in an input signal, wherein the gap corresponds to missing information that was originally included with the input signal, comprising the steps of:
(a) dividing the input signal into a plurality of subbands, each subband comprising a subband signal with a different range of frequencies than other subbands and having a bandwidth substantially less than that of the input signal;
(b) demodulating each of the plurality of subband signals to produce a pair of signals including a carrier signal and a modulator signal;
(c) separately interpolating the carrier signal and the modulator signal comprising each pair of signals to fill in the gap in each carrier signal and in each modulator signal comprising each subband signal, forming interpolated subband signals;
(d) remodulating the interpolated subband signals to combine the interpolated signals for each pair, producing modified subband signals; and
(e) recombining the modified subband signals to produce an interpolated output signal in which the gap is filled-in.

2. The method of claim 1, wherein the gap is up to about 250 milliseconds in duration.

3. The method of claim 1, wherein the step of dividing the input signal into the plurality of subbands comprises the step of processing the input signal with a filterbank that implements short-time Fourier transforms with appropriate windows chosen for analysis and synthesis to produce the plurality of subbands.

4. The method of claim 3, further comprising the step of selecting the bandwidth and location of each subband so that no more than one carrier is included within the subband signal.

5. The method of claim 1, wherein the step of recombining the modified subband signals comprises the step of applying an inverse short-time Fourier transform to the modified subband signals to produce the interpolated output signal.

6. The method of claim 1, wherein the step of demodulating each of the plurality of subband signals comprises the steps of:
(a) detecting the carrier signal in a subband signal; and
(b) dividing the subband signal by the carrier signal to determine the modulator signal for the subband.

7. The method of claim 6, wherein the step of dividing the subband signal comprises the step of multiplying a complex conjugate of the carrier signal for the subband by the subband signal to determine the modulator signal for the subband signal.

8. The method of claim 6, wherein the step of detecting the carrier signal comprises the steps of:
(a) using a sliding M-point window to obtain sequential short-time segments of the subband signal, wherein a length of the M-point window corresponds to an interval of time during which an instantaneous frequency of the subband is expected to remain constant;
(b) determining a spectral center-of-gravity for the sliding M-point window; and
(c) determining a phase of the carrier signal for the subband.

9. The method of claim 1, wherein the step of interpolating the modulator signal for a subband comprises the steps of:
(a) down sampling the modulator signal for the subband;
(b) applying a gap interpolator to the modulator signal that was down sampled to provide an interpolated down sampled modulator signal; and
(c) up sampling the interpolated down sampled modulator signal to produce an interpolated modulator signal.

10. The method of claim 1, wherein the step of interpolating the carrier signal comprises the step of choosing a relatively long instantaneous frequency detection window during the step of demodulating, so that the relatively long instantaneous frequency detection window is longer than the gap and thereby the instantaneous frequency detection window implicitly interpolates the carrier signal by averaging the instantaneous frequency detection window over the gap.

11. The method of claim 1, wherein the step of interpolating the carrier signal comprises the steps of:
(a) interpolating an instantaneous frequency signal of the carrier signal, instead of directly interpolating the carrier signal, producing an interpolated instantaneous frequency signal; and
(b) computing an interpolated carrier signal from the interpolated instantaneous frequency signal.

12. A memory medium on which are stored machine readable and executable instructions for carrying out the steps of claim 1.

13. A system for filling in a gap in an input signal, wherein the gap corresponds to missing information that was originally included with the input signal, comprising:
(a) a memory in which are stored machine executable instructions;
(b) an interface that accesses the input signal in which the gap has occurred;
(c) a processor that is coupled to the memory and to the interface, the processor executing the machine executable instructions to carry out a plurality of functions, including:
(i) dividing the input signal into a plurality of subbands, each subband comprising a subband signal with a different range of frequencies than other subbands and having a bandwidth substantially less than that of the input signal;
(ii) demodulating each of the plurality of subband signals to produce a pair of signals including a carrier signal and a modulator signal;
(iii) separately interpolating the carrier signal and the modulator signal comprising each pair of signals to fill in the gap in each carrier signal and in each modulator signal comprising each subband signal, forming interpolated subband signals;
(iv) remodulating the interpolated subband signals to combine the interpolated signals for each pair, producing modified subband signals; and
(v) recombining the modified subband signals to produce an interpolated output signal in which the gap is filled-in.

14. The system of claim 13, wherein the gap is up to about 250 milliseconds in duration.

15. The system of claim 13, wherein the machine instructions further cause the processor to process the input signal with a filterbank that implements short-time Fourier transforms with appropriate windows chosen for analysis and synthesis to produce the plurality of subbands.

16. The system of claim 15, wherein the machine instructions further cause the processor to select the bandwidth and location of each subband so that no more than one carrier is included within the subband signal.

17. The system of claim 13, wherein the machine instructions further cause the processor to recombine the modified subband signals by applying an inverse short-time Fourier transform to the modified subband signals to produce the interpolated output signal.

18. The system of claim 13, wherein the machine instructions further cause the processor to demodulate each of the plurality of subband signals by:
(a) detecting the carrier signal in a subband signal; and
(b) dividing the subband signal by the carrier signal to determine the modulator signal for the subband.

19. The system of claim 18, wherein the machine instructions further cause the processor to divide the subband signal by multiplying a complex conjugate of the carrier signal for the subband by the subband signal to determine the modulator signal for the subband signal.

20. The system of claim 18, wherein the machine instructions further cause the processor to detect the carrier signal by:
(a) using a sliding M-point window to obtain sequential short-time segments of the subband signal, wherein a length of the M-point window corresponds to an interval of time during which an instantaneous frequency of the subband is expected to remain constant;
(b) determining a spectral center-of-gravity for the sliding M-point window; and
(c) determining a phase of the carrier signal for the subband.

21. The system of claim 13, wherein the machine instructions further cause the processor to modulate the signal for a subband by:
(a) down sampling the modulator signal for the subband;
(b) applying a gap interpolator to the modulator signal that was down sampled to provide an interpolated down sampled modulator signal; and
(c) up sampling the interpolated down sampled modulator signal to produce an interpolated modulator signal.

22. The system of claim 13, wherein the machine instructions further cause the processor to interpolate the carrier signal by choosing a relatively long instantaneous frequency detection window during the step of demodulating, so that the relatively long instantaneous frequency detection window is longer than the gap and thereby the instantaneous frequency detection window implicitly interpolates the carrier signal by averaging the instantaneous frequency detection window over the gap.

23. The system of claim 13, wherein the machine instructions further cause the processor to interpolate the carrier signal by:
(a) interpolating an instantaneous frequency signal of the carrier signal, instead of directly interpolating the carrier signal, producing an interpolated instantaneous frequency signal; and
(b) computing an interpolated carrier signal from the interpolated instantaneous frequency signal.
